(19) United States
(12) Patent Application Publication
(10) Pub. No.: US 2021/0332510 A1
(43) Pub. Date: Oct. 28, 2021

(54) BIDIRECTIONAL LOW TEARING STRENGTH SPACER TEXTILE USING WARP KNITTING

(71) Applicant: JEONGSAN INTERNATIONAL CO., LTD., Busan (KR)

(72) Inventors: Man Young Kim, Busan (KR); Dae Kun Choi, Busan (KR); Jun Hyeong Seo, Busan (KR)

(21) Appl. No.: 17/187,554

(22) Filed: Feb. 26, 2021

(30) Foreign Application Priority Data
Apr. 28, 2020 (KR) 10-2020-005180

(51) Int. Cl. D04B 21/16; B32B 5/02; B32B 5/06; B32B 5/26

(52) U.S. Cl. CPC D04B 21/165; B32B 5/026; B32B 2307/582; B32B 5/26; B32B 5/06

(57) ABSTRACT

The present invention relates to a bidirectional low tearing strength spacer textile using warp knitting, more particularly, relates to a spacer textile comprising a surface textile layer, a rear surface textile layer, and a spacer thread connecting the textile layers, wherein the surface textile layer and the rear surface textile layer include a main thread provided with a plurality of open loops formed with openings in a longitudinal direction.

### CROSS-REFERENCE TO RELATED APPLICATIONS

This application claims priority to Korean Patent Application No. 10-2020-0051800 filed on Apr. 28, 2020, the disclosure of which is expressly incorporated herein by reference.

### STATEMENT RE: FEDERALLY SPONSORED RESEARCH/DEVELOPMENT

Not Applicable

### BACKGROUND

### Technical Field

The present invention relates to a bidirectional low tearing strength spacer textile using warp knitting.

### Background

Currently, the use of 3D warp knitting (Double Raschel) products that can express the same cushioning feeling from low-cost polyurethane foam, which is an existing vehicle cushioning material, is expanding due to increased demand for high-end vehicles and eco-friendly products.

As a prior art, registered utility model No. 20-0238028 discloses warp knitted paper having excellent breathability and cushioning properties. In addition, FIG. 1 shows a structure of conventional warp knitting in the longitudinal and transverse direction, and shows a connection structure in the form of a loop in the longitudinal direction and a connection structure in the form of a loop and a leg in the transverse direction.

However, in the case of a currently applied 3D warp knitting (Double Raschel) product, although there is no problem in expressing the feeling of cushion, it should be easily torn regardless of the longitudinal and transverse directions when it is used in the airbag deployment line, but since the structure in the longitudinal and transverse directions is different due to the characteristics of warp knitting products, there is a limit to obtain the required tearing property values in both directions, and thus, there is a problem that it is not easily torn in both longitudinal and transverse directions.

In addition, even in the case of warp knitting used for a portion of a conventional airbag deployment line, there is a problem in that an excessive amount of an adhesive applied during warp knitting is consumed. In other words, in the case of conventional warp knitting, the gap between loops is large, so a significant amount of the injected adhesive seeps through the gaps of the warp knitting loops and is not used for actual fabric bonding, thereby being a factor of cost increase.

### BRIEF SUMMARY

Therefore, the object of the present invention is to provide a spacer textile utilizing warp knitting that can be easily ruptured when an airbag is deployed due to a certain external force applied thereto regardless of the longitudinal and transverse directions, and having a low tearing strength in both longitudinal and transverse directions while reducing the amount of adhesive used.

In order to achieve the above object, the present invention provides a spacer textile comprising a surface textile layer, a rear surface textile layer, and a spacer thread connecting the textile layers, wherein the surface textile layer and the rear surface textile layer include a main thread provided with a plurality of open loops formed with openings in a longitudinal direction.

According to the present invention, during longitudinal tensioning, the original yarn is easily unwound due to an open loop structure in which an opening of a main thread is formed, and during transverse tensioning, the additional thread is easily torn due to the use of a weak mono yarn, so that a spacer textile with low tearing strength in both directions can be implemented.

In addition, the closed loop of the additional thread is formed discontinuously at a portion being overlapped with the main thread and does not affect the longitudinal properties of the main thread, thereby making it easier to implement low tearing strength during longitudinal tensioning.

In addition, it is possible to provide a spacer textile using warp knitting that has low tearing strength in both longitudinal and transverse directions while reducing the amount of adhesive used during manufacture.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram showing a structure of conventional warp knitting in the longitudinal and transverse directions.

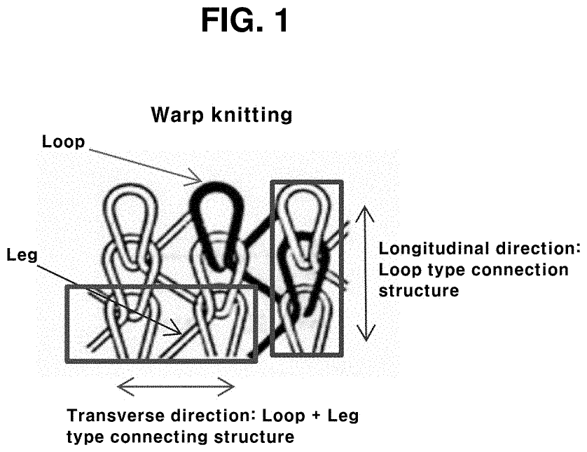

FIG. 2 is a schematic diagram showing a structure of a spacer textile according to an embodiment of the present invention.

FIG. 3 is a schematic diagram showing a structure of an outer surface of a surface textile layer according to an embodiment of the present invention.

FIG. 4 is a schematic diagram showing a structure of an inner side surface of a surface textile layer according to an embodiment of the present invention.

FIG. 5 is a schematic diagram illustrating the main thread structure of FIG. 3 according to an embodiment of the present invention.

FIG. 6 is a schematic diagram illustrating the additional thread structure of FIG. 4 according to an embodiment of the present invention.

FIG. 7 is a schematic diagram illustrating (a) an open loop structure of a main thread and (b) a closed loop structure of an additional thread according to an embodiment of the present invention.

FIG. 8 is a schematic diagram showing a coupling structure of a main thread and an additional thread of a surface textile layer according to an embodiment of the present invention.

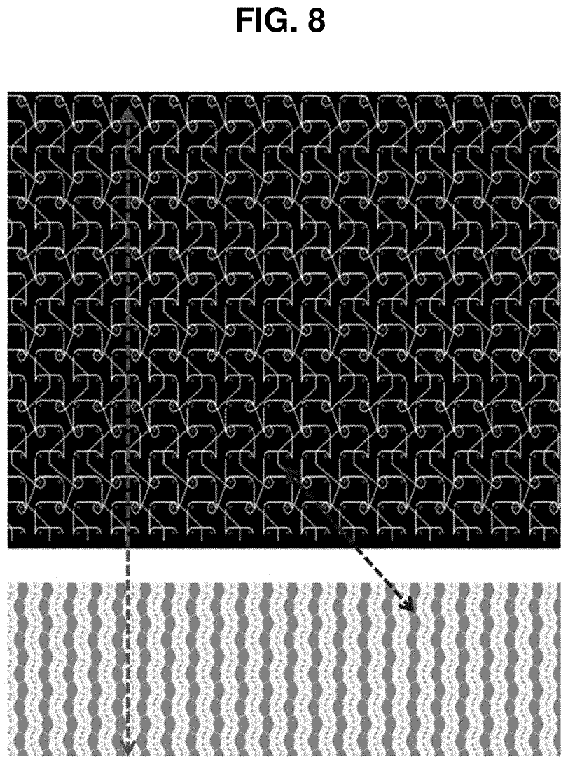

FIG. 9 is (a) a photograph of an actual outer appearance of an outer side surface of a surface textile layer and (b) a photograph of an actual outer appearance of an outer side surface of a textile layer according to an embodiment of the present invention.

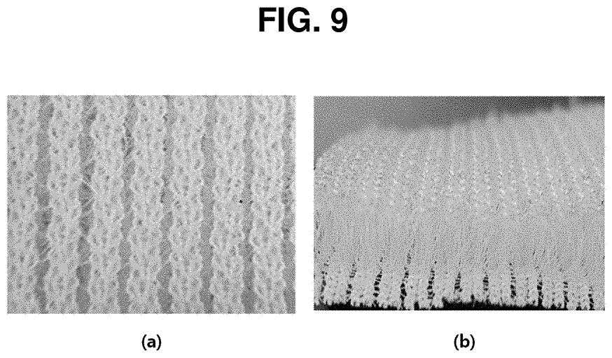

### DETAILED DESCRIPTION

Hereinafter, embodiments of the present invention will be described in more detail with reference to the accompanying drawings, but the following embodiments are for the purpose of explanation only, and are not intended to limit the scope of the present invention.

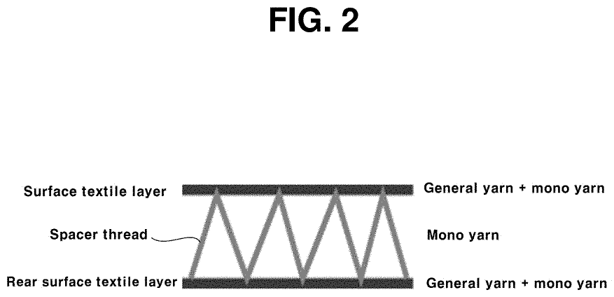

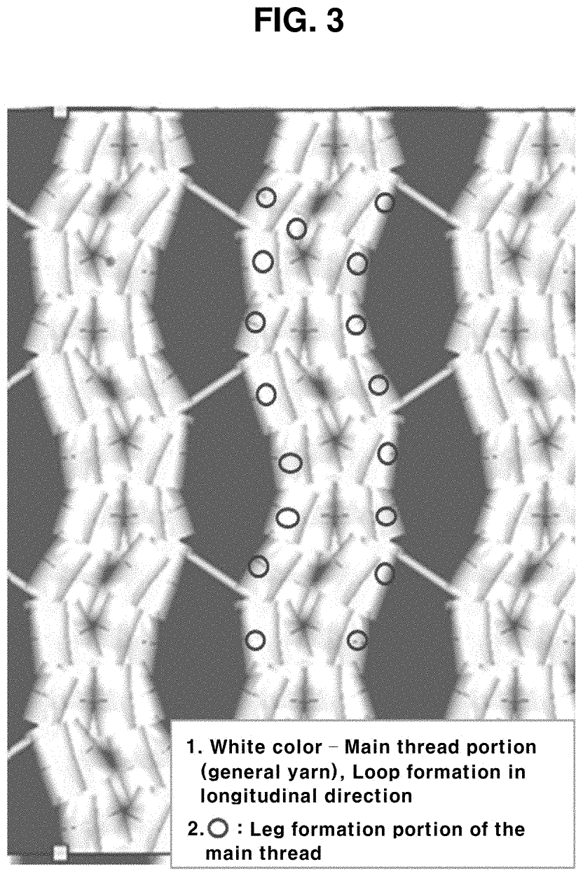

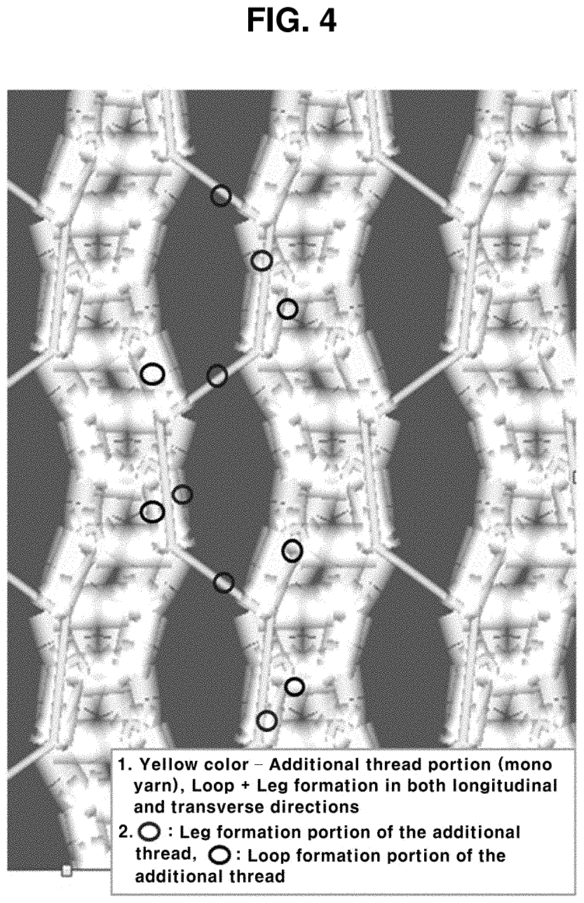

FIG. 2 is a schematic diagram showing a structure of a spacer textile according to an embodiment of the present invention, and FIGS. 3 and 4 are schematic diagrams showing structures of an outer side surface and an inner side surface of a surface textile layer according to an embodiment of the present invention.

Referring to FIGS. 2 to 4, a spacer textile according to the present invention includes a surface textile layer, a rear surface textile layer, and a spacer thread connecting the textile layers.

The surface textile layer and the rear surface textile layer are separated from each other and are connected by spacer threads to have a structure that is symmetrical on the sides opposite from each other. Therefore, for convenience of explanation, the structure and function will be described focusing on the surface textile layer, but the structure of the surface textile layer can be equally applied to the structure of the rear surface textile layer.

The surface textile layer is composed of warp knitting in which the main thread and the additional thread are combined, and forms a loop and leg structure in the longitudinal and transverse directions during weaving.

The main thread is provided with a plurality of open loops formed with openings in the longitudinal direction. That is, in the case of the main thread (white color), a loop-shaped structure is formed at all points in the longitudinal direction, but has an open loop type structure.

The main thread (white) that forms the longitudinal structure forms a loop at all parts, but when an external force is applied in the longitudinal direction the thread can be easily unwound due to the open loop type structure so as to have a low tearing strength.

The additional thread plays the role of connecting the main thread in the transverse direction, and provided with a leg portion connecting the main thread in the transverse direction and a closed loop formed at a portion being overlapped with the main thread.

It is preferable to use a mono yarn so that the additional thread can be easily torn when stretched in the transverse direction. The mono yarn is a monofilament consisting of a single continuous synthetic fiber strand, and the fineness of mono yarn of the additional thread is 20˜70 dtex (deci-tex). The main thread is composed of multi-filament general yarn and has a fineness of 30˜200 dtex. The weight ratio of mono yarn based on the total weight of the surface textile layer is preferably 67.4% by weight.

The spacer thread is formed of a mono yarn, and the fineness may be 20˜110 dtex.

Further, in the present invention, the thickness of the spacer textile may be 1 to 8 mm, more preferably 3.8˜4.2 mm.

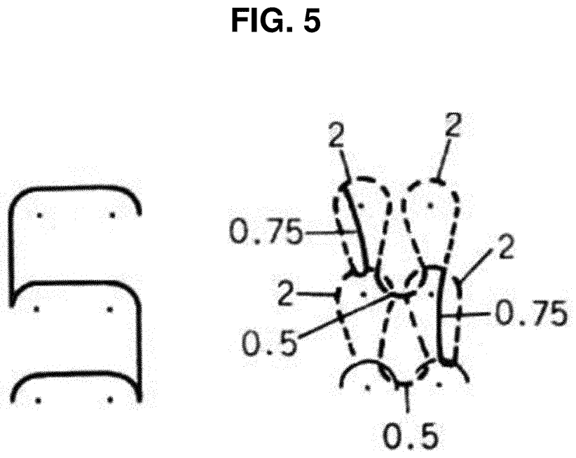

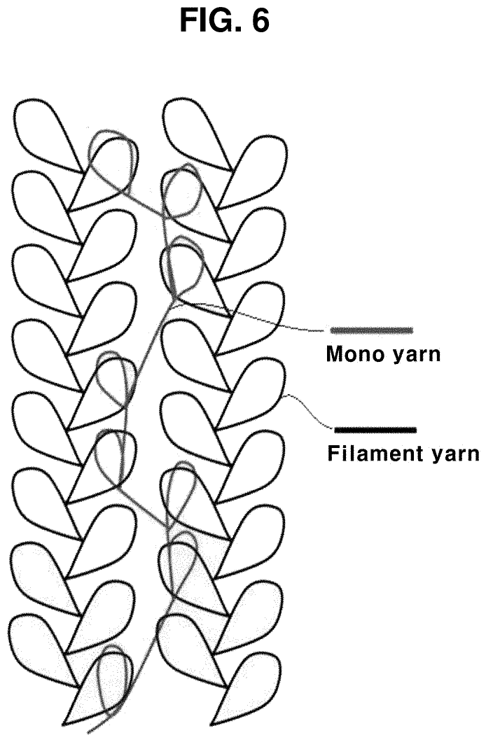

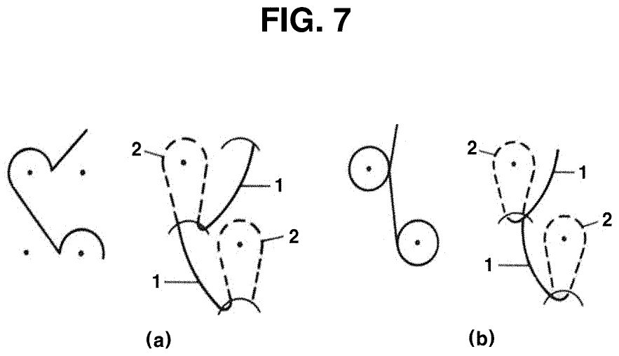

FIG. 5 describes the main thread structure of FIG. 3 according to an embodiment of the present invention, and FIG. 6 is a schematic diagram illustrating an additional thread structure of FIG. 4 according to an embodiment of the present invention. FIG. 7 is a schematic diagram illustrating (a) an open loop structure of a main thread and (b) a closed loop structure of an additional thread according to an embodiment of the present invention.

Referring to FIGS. 5 to 7, an open loop structure is provided in the longitudinal direction so that a portion (weakening point) having low tearing strength in the longitudinal and transverse directions is formed when an external force is applied from the outside, and for transverse connection, mono yarn is applied alone. Through this, the yarn may be broken by force during longitudinal tensioning, the yarn is easily unwound due to the open loop structure, and it can be easily torn due to the weak mono yarn during transverse tensioning.

As an embodiment of the present invention, the number of closed loops of the additional thread may be equal to or less than the number of open loops of the main thread in order to implement low tearing strength during longitudinal tension.

To this end, an open loop is continuously formed on one wale in the main thread, and a closed loop is discontinuously formed at a portion being overlapped with the main thread in the additional thread.

In other words, in the case of the additional thread, a combined structure (loop+leg type structure) in which loop and leg are combined is formed instead of forming a structure all with loops so as not to affect the longitudinal properties of the portion being overlapped with the main thread (white). Due to this, the closed loop of the additional thread is formed discontinuously at the portion being overlapped with the main thread and does not affect the longitudinal properties of the main thread so that a low tearing strength can be realized more easily during longitudinal tensioning.

On the other hand, the present invention has advantages in that since an open loop is continuously formed in one wale of a thick main thread, the void generated by the loop is smaller than that of warp knitting having a conventional discontinuous main thread structure, and as a result, the fabric surface area becomes wider and so that the amount of adhesive being seeped through the fabric surface is reduced, thereby increasing adhesion efficiency.

The spacer thread according to the present invention can easily rupture when a certain external force is applied regardless of the longitudinal and transverse directions when the airbag is deployed, so that it can be applied to warp knitted products for vehicle cushions with low tearing strength in both longitudinal and transverse directions. In addition, it can be applied to interior parts such as cushioning materials for interior parts (instrument panels, door arm rests, door trims, and the like).

Meanwhile, the above detailed description should not be construed as restrictive in all respects and should be considered as illustrative. The scope of the present invention should be determined by reasonable interpretation of the appended claims, and all changes within the equivalent scope of the present invention are included in the scope of the present invention.

What is claimed is:

1. A spacer textile comprising:
a surface textile layer;
a rear surface textile layer; and
a spacer thread connecting the textile layers,
wherein the surface textile layer and the rear surface textile layer include a main thread provided with a plurality of open loops formed with openings in a longitudinal direction,
wherein the surface textile layer and the rear surface textile layer further include an additional thread having a leg portion transversely connected to the main thread and a closed loop formed at a portion being overlapped with the main yarn,
wherein the additional thread is a mono yarn, and
wherein the main thread has an open loop continuously formed on one wale, and the additional thread has a closed loop discontinuously formed at a portion being overlapped with the main yarn.

2. The spacer textile according to claim 1, wherein the number of closed loops of the additional thread is equal to or less than the number of open loops of the main thread.

3. The spacer textile according to claim 1, wherein the fineness of The main thread is 30˜200 dtex, and the fineness of the additional thread is 20˜70 dtex.

4. The spacer textile according to claim 1, wherein the textile is a warp knit textile.
